(19) United States
(12) Patent Application Publication
(10) Pub. No.: US 2026/0066609 A1
(43) Pub. Date: Mar. 5, 2026

(54) LASER AND OPTICAL APPARATUS INCLUDING THE SAME

(71) Applicant: ELECTRONICS AND TELECOMMUNICATIONS RESEARCH INSTITUTE, Daejeon (KR)

(72) Inventors: Dong Hoon SONG, Daejeon (KR); Hong-Seok SEO, Daejeon (KR)

(21) Appl. No.: 19/081,424

(22) Filed: Mar. 17, 2025

(30) Foreign Application Priority Data
Sep. 5, 2024 (KR) 10-2024-0121108

(51) Int. Cl. H01S 3/10; H01S 3/00; H01S 3/0941; H01S 3/1115; H01S 3/16

(52) U.S. Cl. CPC H01S 3/10092; H01S 3/005; H01S 3/09415; H01S 3/1115; H01S 3/1625

(57) ABSTRACT

Provided are a laser and an optical apparatus including the same, the laser including a pump light source configured to generate pump light, a first outer gain medium configured to obtain a gain of seed laser light using the pump light, first and second curved mirrors configured to reflect the seed laser light into the first outer gain medium, a second outer gain medium configured to reobtain the gain of the seed laser light reflected by the first curved mirror and the second curved mirror, third and fourth curved mirrors provided at both sides of the second outer gain medium and configured to reflect the seed laser light into the second outer gain medium, and an inner gain medium provided between the first outer gain medium and the second outer gain medium and configured to reobtain the gain of the seed laser light.

### CROSS-REFERENCE TO RELATED APPLICATION(S)

This U.S. non-provisional patent application claims priority under 35 U.S.C. § 119 of Korean Patent Application No. 10-2024-0121108, filed on Sep. 5, 2024, the entire contents of which are hereby incorporated by reference.

### BACKGROUND

### 1. Field of the Invention

The present disclosure herein relates to an optical apparatus, and more particularly, to a laser and an optical apparatus including the same.

### 2. Description of Related Art

After the invention of the laser in the 1960s, research on the industrial application of the laser has been actively started since the 1970s. CO₂ lasers, developed in 1980, have been used in various fields such as industrial, medical, communication, and display. Solid-state lasers such as diode lasers appeared thereafter have been used in wider fields than CO₂ lasers.

### SUMMARY

The present invention provides a laser capable of making the beam width of seed laser light uniform and/or homogeneous, and an optical apparatus including the same.

An embodiment of the inventive concept provides a laser including: a pump light source configured to generate pump light; a first outer gain medium provided adjacent to the pump light source and configured to obtain a gain of seed laser light using the pump light; a first curved mirror and second curved mirror provided at both sides of the first outer gain medium and configured to reflect the seed laser light into the first outer gain medium; a second outer gain medium parallel to the first outer gain medium, and configured to reobtain the gain of the seed laser light reflected by the first curved mirror and the second curved mirror; a third curved mirror and fourth curved mirror provided at both sides of the second outer gain medium and configured to reflect the seed laser light into the second outer gain medium; and an inner gain medium provided between the first outer gain medium and the second outer gain medium and configured to reobtain the gain of the seed laser light.

In an embodiment, the inner gain medium may have a smaller size than that of the first outer gain medium and the second outer gain medium.

In an embodiment, each of the first and second outer gain media may include a titanium sapphire crystal.

In an embodiment, the laser may further include: a first vertical electrode provided under the first outer gain medium; and a second vertical electrode provided on the first outer gain medium.

In an embodiment, the laser may further include: a third vertical electrode provided under the second outer gain medium; and a fourth vertical electrode provided on the second outer gain medium.

In an embodiment, the laser may further include: a first horizontal electrode provided on one side of the inner gain medium; and a second horizontal electrode provided on another side of the inner gain medium.

In an embodiment, the inner gain medium may include a first saturable absorber having a first absorption rate.

In an embodiment, the laser may further include: a first beam splitter provided between the third curved mirror and the inner gain medium; and a mode-locking unit provided adjacent to the first beam splitter.

In an embodiment, the mode-locking unit may include a second saturable absorber having a second absorption rate higher than the first absorption rate.

In an embodiment, the laser may further include: a third beam splitter between the inner gain medium and the fourth curved mirror; a fourth beam splitter between the inner gain medium and the second curved mirror; a third gain medium provided on one side of the inner gain medium and configured to reobtain the gain the seed laser light; and a fifth curved mirror and sixth curved mirror provided on both sides of the third outer gain medium.

In an embodiment of the inventive concept, an optical apparatus includes: a source laser configured to generate input seed laser light; an amplification element configured to receive the input seed laser light; a seed laser configured to provide the seed laser light into the amplification element to generate output laser light, wherein the seed laser may include: a pump light source configured to generate pump light; a first outer gain medium provided adjacent to the pump light source and configured to obtain a gain of the seed laser light using the pump light; a first curved mirror and second curved mirror provided at both sides of the first outer gain medium and configured to reflect the seed laser light into the first outer gain medium; a second outer gain medium parallel to the first outer gain medium, and configured to reobtain the gain of the seed laser light reflected by the first curved mirror and the second curved mirror; a third curved mirror and fourth curved mirror provided at both sides of the second outer gain medium and configured to reflect the seed laser light into the second outer gain medium; and an inner gain medium provided between the first outer gain medium and the second outer gain medium and configured to reobtain the gain of the seed laser light.

In an embodiment, the amplification element may include: a first resonant mirror; a second resonant mirror facing the first resonant mirror; and a main gain medium between the first resonant mirror and the second resonant mirror.

In an embodiment, the amplification element may further include: a first dichroic mirror configured to transmit the input seed laser light and reflect the output laser light; and a second dichroic mirror between the first resonant mirror and the main gain media.

In an embodiment, the amplification element may further include: a first polarization plate between the first dichroic mirror and the second dichroic mirror; and a second polarization plate between the first resonant mirror and the second dichroic mirror.

In an embodiment, the amplification element may further include: a Faraday rotator between the first polarization plate and the second dichroic mirror; and a modulator between the second polarization plate and the first resonant mirror.

In an embodiment of the inventive concept, a laser includes: a pump light source configured to generate pump light; a first outer gain medium provided adjacent to the pump light source and configured to obtain a gain of seed laser light using the pump light; a first curved mirror and second curved mirror provided at both sides of the first outer gain medium and configured to reflect the seed laser light into the first outer gain medium; a second outer gain medium parallel to the first outer gain medium, and configured to reobtain the gain of the seed laser light reflected by the first curved mirror and the second curved mirror; a third curved mirror and fourth curved mirror provided at both sides of the second outer gain medium and configured to reflect the seed laser light into the second outer gain medium; an inner gain medium provided between the first outer gain medium and the second outer gain medium and configured to reobtain the gain of the seed laser light; a first beam splitter between the inner gain medium and the third curved mirror; a mode-locking unit provided adjacent to the first beam splitter and configured to generate a pulse of the seed laser light; a second beam splitter between the inner gain medium and the first curved mirror; and an output mirror provided adjacent to the second beam splitter and configured to output the seed laser light outside.

In an embodiment, each of the first and second outer gain media may have a first length, and the inner gain medium may have a second length smaller than the first length.

In an embodiment, each of the first and second outer gain media may include a titanium sapphire crystal, and the inner gain medium may include a first saturable absorber with a first absorption rate.

In an embodiment, the mode-locking unit may include a second saturable absorber having a second absorption rate higher than the first absorption rate.

In an embodiment, the laser may further include: a third beam splitter between the inner gain medium and the fourth curve mirror; a fourth beam splitter between the inner gain medium and the second curved mirror; a third gain medium provided on one side of the inner gain medium and configured to reobtain the gain the seed laser light; and a fifth curved mirror and sixth curved mirror provided at both sides of the third outer gain medium, wherein the third outer gain medium may include a nonlinear crystal.

### BRIEF DESCRIPTION OF THE DRAWINGS

The accompanying drawings are included to provide a further understanding of the inventive concept, and are incorporated in and constitute a part of this specification. The drawings illustrate embodiments of the inventive concept and, together with the description, serve to explain principles of the inventive concept. In the drawings:

FIG. 1 is a block diagram showing an example optical apparatus according to the present inventive concept;

FIG. 2 shows an example seed laser of FIG. 1;

FIG. 3 is a perspective view showing an example of a pump light source of FIG. 2;

FIG. 4 is a graph showing an example femtosecond pulse of seed laser light generated by a mode-locking unit of FIG. 2;

FIG. 5 shows positive self-phase modulation, negative self-phase modulation, and balanced self-phase modulation of the femtosecond pulse of FIG. 4;

FIG. 6 shows an example seed laser of FIG. 1;

FIG. 7 is a block diagram showing an example of an amplification element of FIG. 1; and

FIG. 8 is a block diagram showing an example of the amplification element of FIG. 1.

### DETAILED DESCRIPTION

Hereinafter, specific embodiments will be described in detail with reference to the accompanying drawings. Advantages and features of the present invention, and methods for achieving the same will be cleared with reference to exemplary embodiments described later in detail together with the accompanying drawings. The inventive concept may, however, be embodied in different forms and should not be construed as limited to the embodiments set forth herein. Rather, these embodiments are provided so that this disclosure will be thorough and complete, and will fully convey the scope of the inventive concept to those skilled in the art. The present disclosure is defined by only scopes of the claims. Throughout this specification, like numerals refer to like elements.

The terms and words used in the following description and claims are to describe embodiments but are not limited the inventive concept. As used herein, the singular forms “a”, “an” and “the” are intended to include the plural forms as well, unless the context clearly indicates otherwise. It will be further understood that the terms “comprises” and/or “comprising” used herein specify the presence of stated components, operations and/or elements but do not preclude the presence or addition of one or more other components, operations and/or elements. In the specification, a femtosecond pulse, self-phase modulation, and mode locking may be understood as meanings mainly used in the field of optics. In addition, as just exemplary embodiments, reference numerals shown according to an order of description are not limited to the order.

The foregoing description is about detailed examples for carrying out the inventive concept. The present disclosure includes not only the foregoing embodiments but also simply changed or easily modified embodiments. In addition, the present disclosure may also include technologies that can be easily modified and carried out in the future using the foregoing embodiments.

Hereinafter, embodiments of the inventive concept will be described in detail with reference to the accompanying drawings.

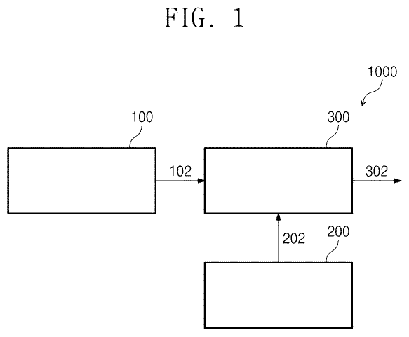

FIG. 1 shows an example optical apparatus 1000 according to the present inventive concept.

Referring to FIG. 1, the optical apparatus 1000 may include a laser light amplification apparatus. According to an example, the optical apparatus 1000 according to the inventive concept may include a seed laser 100, a source laser 200, and an amplification element 300. The seed laser 100 may be connected to the amplification element 300. The seed laser 100 may provide seed laser light 102 to the amplification element 300. The source laser 200 may be connected to the amplification element 300. The source laser 200 may provide source laser light 202 to the amplification element 300. The amplification element 300 may use the seed laser light 102 to amplify the source laser light 202 and generate output laser light 302. The output laser light 302 may have a greater intensity than the source laser light 202.

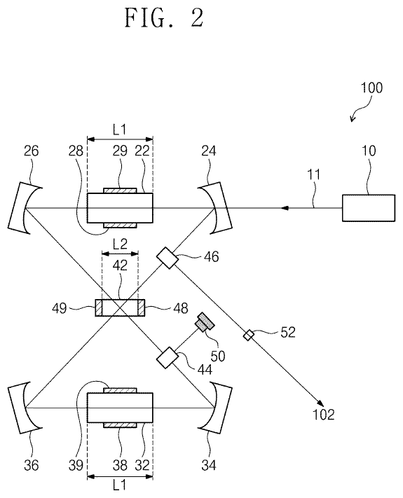

FIG. 2 shows an example of the seed laser 100 of FIG. 1.

Referring to FIG. 2, the seed laser 100 may include a femtosecond pulse laser. According to an example, the seed laser 100 may include a pump light source 10, a first outer gain medium 22, a first curved mirror 24, a second curved mirror 26, a second outer gain medium 32, a third curved mirror 34, a fourth curved mirror 36, an inner gain medium 42, a mode-locking unit 50, and an output mirror 52.

The pump light source 10 may generate pump light 11 to provide the pump light to the first outer gain medium 20, the second outer gain medium 32, and the inner gain medium 42. The first outer gain medium 20, the first curved mirror 24, the second curved mirror 26, the second outer gain medium 32, the third curved mirror 34, the fourth curved mirror 36, and the inner gain medium 42 may serve as a plurality of resonators configured to use the pump light 11 to generate the seed laser light 102.

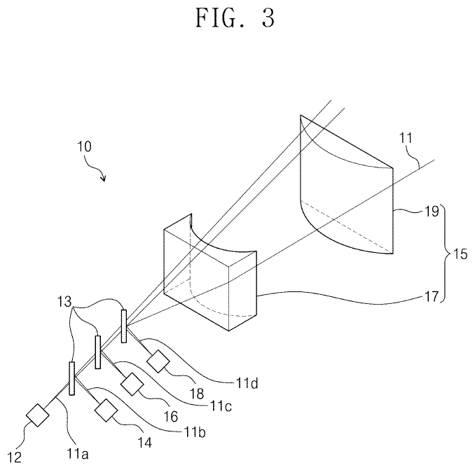

FIG. 3 shows an example of the pump light source 10 of FIG. 2.

Referring to FIG. 3, the pump light source 10 may include a first laser diode 12, a second laser diode 14, a third laser diode 16, a fourth laser diode 18, and cylindrical lenses 15.

The first laser diode 12 may generate first pump light 11a. For example, the first pump light 11a may have the wavelength of about 450 nm. The first pump light 11a may include blue seed laser light.

The second laser diode 14 may generate second pump light 11b. The second pump light 11b may have a longer wavelength than the first pump light 11a. For example, the second pump light 11b may have the wavelength of about 468 nm. The second pump light 11b may include sky blue seed laser light.

The third laser diode 16 may generate third pump light 11c. The third pump light 11c may have a longer wavelength than the second pump light 11b. The second pump light 11c may have the wavelength of about 490 nm. The third pump light 11c may include green blue seed laser light.

The fourth laser diode 18 may generate fourth pump light 11d. The fourth pump light 11d may have a longer wavelength than the third pump light 11c. The fourth pump light 11d may have the wavelength of about 520 nm. The fourth pump light 11d may include green seed laser light.

Beam splitters 13 may be provided between the first laser diode 12, the second laser diode 14, the third laser diode 16, and the fourth laser diode 18. The beam splitters 13 may transmit the first pump light 11a, and transmit and reflect the second pump light 11b, the third pump light 11c, and the fourth pump light 11d.

The cylindrical lenses 15 may be provided adjacent to one of the beam splitters 13. The cylindrical lenses 15 may be provided between one of the beam splitters 13 and the first curved mirror 24 of FIG. 2. The cylindrical lenses 15 may magnify the pump light 11. The pump light 11 may be provided to a sidewall of the first outer gain medium 22. According to an example, the cylindrical lenses 15 may include a first cylindrical lens 17 and a second cylindrical lens 19.

The first cylindrical lens 17 may be provided between one of the beam splitters 13 and the second cylindrical lens 19. The first cylindrical lens 17 may include a concave cylindrical lens. The first cylindrical lens 17 may magnify and/or expand the pump light 11.

The second cylindrical lens 19 may be provided at the other side of the first cylindrical lens 17 that faces the beam splitters 13. The second cylindrical lens 19 may include a convex cylindrical lens. The second cylindrical lens 19 may collimate the pump light 11.

Referring again to FIG. 2, the first outer gain medium 22 may be provided between the first curved mirror 24 and the second curved mirror 26. The first outer gain medium 22 may receive the pump light 11 to obtain the gain of the seed laser light 102. In addition, the first outer gain medium 22 may scatter and/or diffract the seed laser light 102. The first outer gain medium 22 may have a rectangular parallelepiped shape. For example, the first outer gain medium 22 may include a titanium sapphire crystal. The first outer gain medium 22 may have a first length L1 of about 0.1 cm to about 10 cm. According to an example, the first outer gain medium 22 may have a first vertical electrode 28 and a second vertical electrode 29. The first vertical electrode 28 and the second vertical electrode 29 may be respectively disposed under and over the first outer gain medium 22. The first vertical electrode 28 and the second vertical electrode 29 may provide a current, an electric field, or a sound wave into the first outer gain medium 22 to tune a wavelength band of the seed laser light 102. Each of the first vertical electrode 28 and the second vertical electrode 29 may include a metal such as gold (Au), silver (Ag), copper (Cu), aluminum (Al), or tungsten (W).

The first curved mirror 24 may be provided between the first outer gain medium 22 and the pump light source 10. The first curved mirror 24 may transmit the pump light 11 and reflect the seed laser light 102 to the first outer gain medium 22. For example, the first curved mirror 24 may include a dichroic curved mirror.

The second curved mirror 26 may be provided at the other side of the first outer gain medium 22. The second curved mirror 26 may reflect a portion (e.g., 0-th order diffracted light (0th)) of the seed laser light 102 to the first outer gain medium 22, the second outer gain medium 32, and the inner gain medium 42.

The second outer gain medium 32 may be parallel with the first outer gain medium 22. The second outer gain medium 32 may receive the pump light 11 to reobtain the gain of the seed laser light 102. The second outer gain medium 32 may scatter and/or diffract the seed laser light 102. The second outer gain medium 32 may have a rectangular parallelepiped shape. For example, the second outer gain medium 32 may include a titanium sapphire crystal. The second outer gain medium 32 may have the first length L1 of about 0.1 cm to about 10 cm. According to an example, the second outer gain medium 32 may have a third vertical electrode 38 and a fourth vertical electrode 39. The third vertical electrode 38 and the fourth vertical electrode 39 may be respectively disposed under and above the second outer gain medium 32. The third vertical electrode 38 and the fourth vertical electrode 39 may provide a current, an electric field, or a sound wave into the second outer gain medium 32 to tune the wavelength band of the seed laser light 102. Each of the third vertical electrode 38 and the fourth vertical electrode 39 may include a metal such as gold (Au), silver (Ag), copper (Cu), aluminum (Al), or tungsten (W).

The third curved mirror 34 and the fourth curve mirror 36 may be respectively provided at both sides of the second outer gain medium 32. The third curved mirror 34 may receive the pump light 11 and the seed laser light 102 from the second curved mirror 26 to reflect the received pump light and seed laser light to the second outer gain medium 32. The fourth curved mirror 36 may receive the pump light 11 and the seed laser light 102 from the first curved mirror 24 to reflect the received pump light and seed laser light to the second outer gain medium 32.

The inner gain medium 42 may be provided between the first outer gain medium 22 and the second outer gain medium 32. The inner gain medium 42 may be provided between the first curved mirror 24 and the fourth curved mirror 36. The inner gain medium 42 may be provided between the second curved mirror 26 and the third curved mirror 34. The inner gain medium 42 may receive the pump light 11 to reobtain the gain of the seed laser light 102. In addition, the inner gain medium 42 may cause the seed laser light 102 between the second curved mirror 26 and the third curved mirror 34 and the seed laser light 102 between the first curved mirror 24 and the fourth curved mirror 36 to simultaneously resonate to maximize the gain efficiency of the seed laser light 102. The inner gain medium 42 may include a first saturable absorber with a first absorption rate of about 0.1 % to about 0.5 %. For example, the inner gain medium 42 may include alexandrite or chromium chrysoberyl. The inner gain medium 42 may be smaller than the first outer gain medium 22 and the second outer gain medium 32. The inner gain medium 42 may have a second length L2. The second length L2 may be smaller than the first length L1. The second length L2 may be about 1 mm to about 8 mm. The inner gain medium 42 may be thinner than the first outer gain medium 22 and the second outer gain medium 32. According to an example, the inner gain medium 42 may have a first horizontal electrode 48 and a second horizontal electrode 49. The first horizontal electrode 48 and the second horizontal electrode 49 may be provided on both sides of the inner gain medium 42. The first horizontal electrode 48 and the second horizontal electrode 49 may provide a current, an electric field, or a sound wave into the inner gain medium 42 to tune the wavelength band of the seed laser light 102.

A first beam splitter 44 may be provided between the inner gain medium 42 and the third curved mirror 34. The first beam splitter 44 may provide a portion of the seed laser light 102 to a mode locking unit 50.

The mode locking unit 50 may be provided adjacent to the first beam splitter 44.

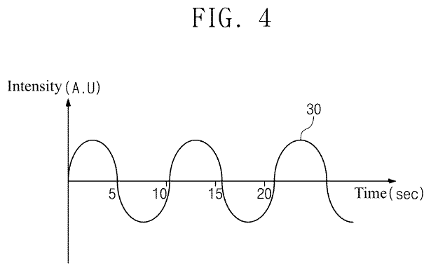

FIG. 4 shows an example of the femtosecond pulse 30 of the seed laser light 102 generated by the mode locking unit 50.

Referring to FIGS. 2 and 4, the mode locking unit 50 may receive the seed laser light 102 to generate the femtosecond pulse 30 of the seed laser light 102. For example, the femtosecond pulse 30 may have the bandwidth of about 10.7 nm. The mode locking unit 50 may include a second saturable absorber with a second absorption rate higher than the first absorption rate of the first saturable absorber. The second absorption rate of the second saturable absorber may be about 1% to about 5%. For example, the mode locking unit 50 may include a gallium arsenide-based crystal having a modulation depth of about 0.1 % to about 5 %. The second saturable absorber may generate the femtosecond pulse 30 of the seed laser light 102 based on nonlinear mode locking. The mode locking may be derived by the nonlinear optical Kerr effect. In addition, the mode locking unit 50 may include a chirp mirror or a prism, but is not limited thereto.

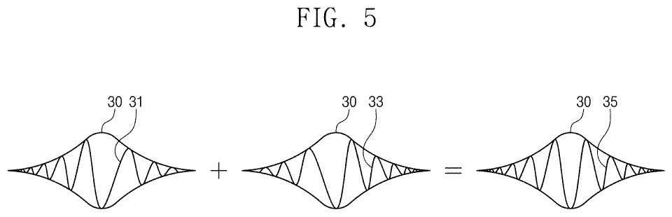

FIG. 5 shows positive self-phase modulation 31, negative self-phase modulation 33, and balanced self-phase modulation 35 of the femtosecond pulse 30 of FIG. 4.

Referring to FIGS. 2 and 5, the first outer gain medium 22, the second outer gain medium 32, the inner gain medium 42, and the mode locking unit 50 may generate the positive self-phase modulation 31 of the seed laser light 102. The positive self-phase modulation 31 may be generated by the pump light source 10, the first curved mirror 24, the second curved mirror 26, the third curved mirror 34, and the fourth curved mirror 36, but is not limited thereto. The positive self-phase modulation 31 may be displayed that the phase of the seed laser light 102 in the femtosecond pulse 30 is tilted to the right. Typically, the positive self-phase modulation 31 shows that the nonlinear optical effect of the seed laser light 102 appears uniformly or non-homogeneously in the first outer gain medium 22, the second outer gain medium 32, the inner gain medium 42, and the mode-locking unit 50. Although not shown, the first outer gain medium 22, the second outer gain medium 32, the inner gain medium 42, and the mode locking unit 50 may generate a positive variance value of the seed laser light 102.

The first vertical electrode 28, the second vertical electrode 29, the third vertical electrode 38, the fourth vertical electrode 39, the first horizontal electrode 48 and the second horizontal electrode 49 may generate the negative self-phase modulation 33 of the seed laser light 102 using the current, the electric filed, or the sound wave. The negative self-phase modulation 33 may be displayed that the phase of the seed laser light 102 in the femtosecond pulse 30 is tilted to the left. The negative self-phase modulation 33 may compensate for the positive self-phase modulation 31 to be changed to the balanced self-phase modulation 35. In addition, the first vertical electrode 28, the second vertical electrode 29, the third vertical electrode 38, the fourth vertical electrode 39, the first horizontal electrode 48 and the second horizontal electrode 49 may use the current, the electric filed, or the sound wave to generate a negative variance value of the seed laser light 102 and compensate for the positive variance value in the first outer gain medium 32, the second outer gain medium 32, the inner gain medium, and the mode locking unit to improve the nonlinear optical effect of the seed laser light 102.

Accordingly, the seed laser 100 may generate the femtosecond pulse 30 having the balanced self-phase modulation 35 of the nonlinear optical effect using the first vertical electrode 28, the second vertical electrode 29, the third vertical electrode 38, the fourth vertical electrode 39, the first horizontal electrode 48 and the second horizontal electrode 49. In addition, the seed laser 100 may make the beam width of the seed laser light 102 uniform and/or homogeneous using the first vertical electrode 28, the second vertical electrode 29, the third vertical electrode 38, the fourth vertical electrode 39, the first horizontal electrode 48 and the second horizontal electrode 49.

Referring again to FIG. 2, a second beam splitter 46 may be provided between the first curved mirror 24 and the inner gain medium 42. The second beam splitter 46 may provide a portion of the seed laser light 102 to the output mirror 52.

The output mirror 52 may be provided adjacent to the second beam splitter 46. The output mirror 52 may provide the seed laser light 102 to the amplification element 300 of FIG. 1. For example, the output mirror 52 may include a half-mirror, but is not limited thereto.

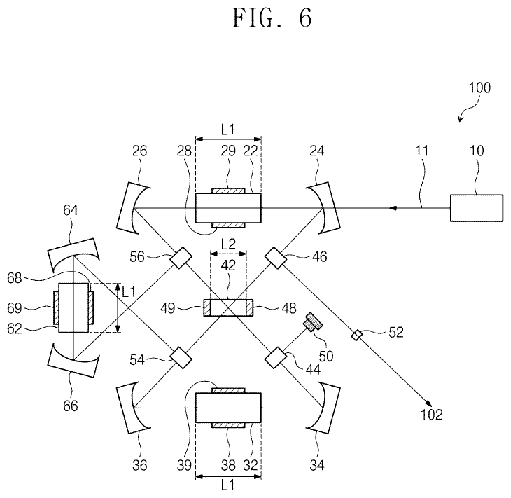

FIG. 6 shows an example of the seed laser 100 of FIG. 1.

Referring to FIG. 6, the seed laser 100 may further include a third beam splitter 54, a fourth beam splitter 56, a third outer gain medium 62, a fifth curved mirror 64, and a sixth curved mirror 66.

The third beam splitter 54 may be provided between the inner gain medium 42 and the fourth curved mirror 36. The third beam splitter 54 may reflect a portion of the pump light 11 and the seed laser light 102 to the fifth curved mirror 64 and the third outer gain medium 62.

The fourth beam splitter 56 may be provided between the inner gain medium 42 and the second curved mirror 26. The fourth beam splitter 56 may reflect a portion of the pump light 11 and the seed laser light 102 to the sixth curved mirror 64 and the third outer gain medium 62.

The third outer gain medium 62 may be provided to one of the inner gain medium 42 and the second horizontal electrode 49. The third outer gain medium 62 may be provided between the fifth curved mirror 64 and the sixth curved mirror 66. The third outer gain medium 62 may receive the pump light 11 to reobtain the gain of the seed laser light 102. The third outer gain medium 62 may cause the seed laser light 102 between the fifth curved mirror 64 and the sixth curved mirror 66 to resonate to maximize the gain efficiency of the seed laser light 102. The third outer gain medium 62 may include a nonlinear crystal. For example, the third outer gain medium 62 may include beta barium borate (BBO), periodically poled potassium titanyl phosphate (PPKTP), and periodically poled lithium niobate (PPLN). The third outer gain medium 62 may further include silicon (Si), silicon nitride (SiN), aluminum gallium arsenide (ALGaAs), or silicon carbide (SiC), but is not limited thereto. The third outer gain medium 62 may have the same or similar size to the first outer gain medium 22 and the second outer gain medium 32. The third outer gain medium 62 may have the first length L1 of about 0.1 cm to about 10 cm. According to an example, the third outer gain medium 62 may have a third horizontal electrode 68 and a fourth horizontal electrode 69. The third horizontal electrode 68 and the fourth horizontal electrode 69 may be provided on both sides of the third outer gain medium 62. The third horizontal electrode 68 and the fourth horizontal electrode 69 may provide a current, an electric field, or a sound wave into the third outer gain medium 62 to tune the wavelength band of the seed laser light 102, or make the beam width of the seed laser light 102 uniform and/or homogeneous.

The pump light source 10, the first outer gain medium 22, the first curved mirror 24, the second curved mirror 26, the second outer gain medium 32, the third curved mirror 34, the fourth curved mirror 36, the inner gain medium 42, the first beam splitter 44, the second beam splitter 46, the mode locking unit 50, and the output mirror 52 may be configured identically to those of FIG. 2.

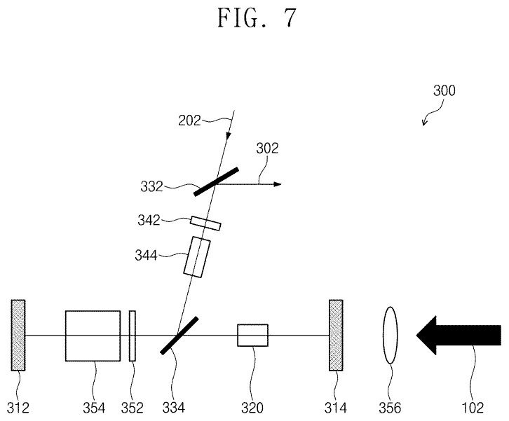

FIG. 7 shows an example of the amplification element 300 of FIG. 1.

Referring to FIG. 7, the amplification element 300 may include a first resonant mirror 312, a second resonant mirror 314, a main gain medium 320, a first dichroic mirror 332, a second dichroic mirror 334, a first polarization plate 342, a Faraday rotator 344, a second polarization plate 353, and a modulator 354.

The first resonant mirror 312 may be provided at one side of the main gain medium 320.

The second resonant mirror 314 may be provided at the other side of the first outer gain medium 320 facing the first resonant mirror 312. The seed laser light 102 may be transmitted through the second resonant mirror 314 to be provided into the main gain medium 320. A second convex lens 356 may be provided adjacent to the second resonant mirror 314. The second convex lens 356 may focus the seed laser light 102 on the main gain medium 320.

The main gain medium 320 may be provided between the first resonant mirror 312 and the second resonant mirror 314. The main gain medium 320 may absorb the seed laser light 102 and the source laser light 202 to obtain the gain of the output laser light 302. The main gain medium 320 may have the same material as the first outer gain medium 22. For example, the main gain medium 320 may include a titanium sapphire crystal.

The first dichroic mirror 332 may be provided on the main gain medium 320. The first dichroic mirror 332 may transmit the source laser light 202, and reflect the output laser light 302 outside.

The second dichroic mirror 334 may be provided between the first resonant mirror 312 and the main gain medium 320. The second dichroic mirror 334 may reflect the source laser light 202 to the first resonant mirror 312, and a portion of the output laser light 302 to the first dichroic mirror 332.

The first polarization plate 342 may be provided between the first dichroic mirror 332 and the second dichroic mirror 334. The first polarization plate 342 may include a linear polarizer. For example, the first polarization plate 342 may include a thin-film polarization plate, but is not limited thereto. The first polarization plate 342 may convert the polarization of the source laser light 202 from p polarization to s polarization. The first polarization plate 342 may convert the polarization of the source laser light 202 from s polarization to p polarization.

The Faraday rotator 344 may be provided between the first polarization plate 342 and the second dichroic mirror 334. The Faraday rotator 344 may include a ferromagnetic crystal, but is not limited thereto. The Faraday rotator 344 may use the magnetic optical effect to rotate the source laser light 202 and/or the output laser light 302 in the azimuthal direction.

The second polarization plate 352 may be provided between the second dichroic mirror 334 and the first resonant mirror 312. The second polarization plate 352 may include a circular polarizer. The second polarization plate 352 may perform circular polarization on the source laser light 202 and/or the output laser light 302.

The modulator 354 may be provided between the second polarization plate 352 and the first resonant mirror 312. The modulator 354 may modulate the source laser light 202 and/or the output laser light 302.

Accordingly, the amplification element 300 may use the seed laser light 102 and the source laser light 202 to obtain the output laser light 302.

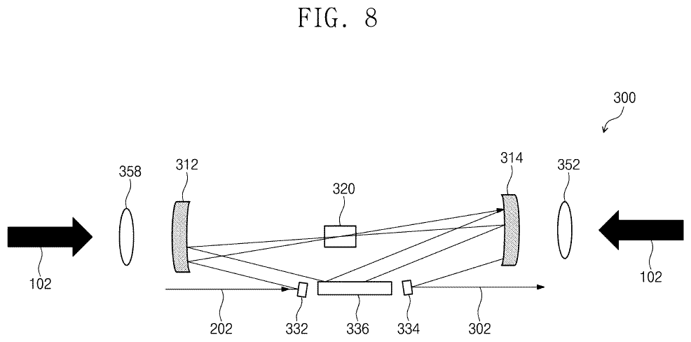

FIG. 8 shows an example of the amplification element 300 of FIG. 1.

Referring to FIG. 8, the first resonant mirror 312 and the second resonant mirror 314 of the amplification element 300 may include curved mirrors having different radii of curvature. For example, the first resonant mirror 312 may have the radius of curvature of about 1 m. The second resonant mirror 314 may have the radius of curvature of about 0.9 m.

According to an example, the amplification element 300 may further include a first edge mirror 332, a second edge mirror 334, and a center mirror 336. The first edge mirror 332, the second edge mirror 334, and the center mirror 336 may be provided between the first resonant mirror 312 and the second resonant mirror 314. The first edge mirror 332, the second edge mirror 334, and the center mirror 336 may reflect the source laser light 202 and the output laser light 302.

The first edge mirror 362 may be provided between the first resonant mirror 312 and the center mirror 366. The first edge mirror 362 may reflect the source laser light 312 to the first resonant mirror 312.

The second edge mirror 364 may be provided between the second resonant mirror 314 and the center mirror 366. The second edge mirror 364 may receive the output laser light 302 from the second resonant mirror 314. The second edge mirror 364 may reflect the output laser light 302 outside.

The center mirror 366 may be provided between the first edge mirror 362 and the second edge mirror 364. The center mirror 366 may be provided under the main gain medium 320. The center mirror 366 may reflect the output laser light 302 to the first resonant mirror 312 and the second resonant mirror 314. The power of the output laser light 302 may greater than that of the source laser light 202.

The second convex lens 356 and the third convex lens 358 may be provided at both edges of the first resonant mirror 312 and the second resonant mirror 314. The second convex lens 356 and the third convex lens 358 may focus the source laser light 202 on the main gain medium 320.

As described above, the laser according to an embodiment of the inventive concept may use the first to fourth vertical electrodes, combined with the first and second outer gain media and the inner gain medium, and the first and second horizontal electrodes to make the beam width of the seed laser light uniform and/or homogeneous.

The foregoing description is about detailed examples for practicing the inventive concept. The present disclosure includes not only the above-described embodiments but also simply changed or easily modified embodiments. In addition, the inventive concept may also include technologies obtained by easily modifying and practicing the above-described embodiments.

What is claimed is:

1. A laser comprising:
a pump light source configured to generate pump light;
a first outer gain medium provided adjacent to the pump light source and configured to obtain a gain of seed laser light using the pump light;
a first curved mirror and second curved mirror provided at both sides of the first outer gain medium and configured to reflect the seed laser light into the first outer gain medium;
a second outer gain medium parallel to the first outer gain medium, and configured to reobtain the gain of the seed laser light reflected by the first curved mirror and the second curved mirror;
a third curved mirror and fourth curved mirror provided at both sides of the second outer gain medium and configured to reflect the seed laser light into the second outer gain medium; and
an inner gain medium provided between the first outer gain medium and the second outer gain medium and configured to reobtain the gain of the seed laser light.

2. The laser of claim 1, wherein the inner gain medium has a smaller size than that of the first outer gain medium and the second outer gain medium.

3. The laser of claim 1, wherein each of the first and second outer gain media comprises a titanium sapphire crystal.

4. The laser of claim 1, further comprising:
a first vertical electrode provided under the first outer gain medium; and
a second vertical electrode provided on the first outer gain medium.

5. The laser of claim 1, further comprising:
a third vertical electrode provided under the second outer gain medium; and
a fourth vertical electrode provided on the second outer gain medium.

6. The laser of claim 1, further comprising:
a first horizontal electrode provided on one side of the inner gain medium; and
a second horizontal electrode provided on another side of the inner gain medium.

7. The laser of claim 1, wherein the inner gain medium comprises a first saturable absorber having a first absorption rate.

8. The laser of claim 7, further comprising:
a first beam splitter provided between the third curved mirror and the inner gain medium; and
a mode-locking unit provided adjacent to the first beam splitter.

9. The laser of claim 8, wherein the mode-locking unit comprises a second saturable absorber having a second absorption rate higher than the first absorption rate.

10. The laser of claim 1, further comprising:
a third beam splitter between the inner gain medium and the fourth curved mirror;
a fourth beam splitter between the inner gain medium and the second curved mirror;
a third gain medium provided on one side of the inner gain medium and configured to reobtain the gain the seed laser light; and
a fifth curved mirror and sixth curved mirror provided on both sides of the third outer gain medium.

11. An optical apparatus comprising:
a source laser configured to generate input seed laser light;
an amplification element configured to receive the input seed laser light;
a seed laser configured to provide the seed laser light into the amplification element to generate output laser light,
wherein the seed laser comprises:
a pump light source configured to generate pump light;
a first outer gain medium provided adjacent to the pump light source and configured to obtain a gain of the seed laser light using the pump light;
a first curved mirror and second curved mirror provided at both sides of the first outer gain medium and configured to reflect the seed laser light into the first outer gain medium;
a second outer gain medium parallel to the first outer gain medium, and configured to reobtain the gain of the seed laser light reflected by the first curved mirror and the second curved mirror;
a third curved mirror and fourth curved mirror provided at both sides of the second outer gain medium and configured to reflect the seed laser light into the second outer gain medium; and
an inner gain medium provided between the first outer gain medium and the second outer gain medium and configured to reobtain the gain of the seed laser light.

12. The optical apparatus of claim 11, wherein the amplification element comprises:
a first resonant mirror;
a second resonant mirror facing the first resonant mirror; and
a main gain medium between the first resonant mirror and the second resonant mirror.

13. The optical apparatus of claim 12, wherein the amplification element further comprises:
a first dichroic mirror configured to transmit the input seed laser light and reflect the output laser light; and
a second dichroic mirror between the first resonant mirror and the main gain media.

14. The optical apparatus of claim 13, wherein the amplification element further comprises:
a first polarization plate between the first dichroic mirror and the second dichroic mirror; and
a second polarization plate between the first resonant mirror and the second dichroic mirror.

15. The optical apparatus of claim 14, wherein the amplification element further comprises:
a Faraday rotator between the first polarization plate and the second dichroic mirror; and
a modulator between the second polarization plate and the first resonant mirror.

16. A laser comprising:
a pump light source configured to generate pump light;
a first outer gain medium provided adjacent to the pump light source and configured to obtain a gain of seed laser light using the pump light;
a first curved mirror and second curved mirror provided at both sides of the first outer gain medium and configured to reflect the seed laser light into the first outer gain medium;
a second outer gain medium parallel to the first outer gain medium, and configured to reobtain the gain of the seed laser light reflected by the first curved mirror and the second curved mirror;
a third curved mirror and fourth curved mirror provided at both sides of the second outer gain medium and configured to reflect the seed laser light into the second outer gain medium;
an inner gain medium provided between the first outer gain medium and the second outer gain medium and configured to reobtain the gain of the seed laser light;
a first beam splitter between the inner gain medium and the third curved mirror;
a mode-locking unit provided adjacent to the first beam splitter and configured to generate a pulse of the seed laser light;
a second beam splitter between the inner gain medium and the first curved mirror; and
an output mirror provided adjacent to the second beam splitter and configured to output the seed laser light outside.

17. The laser of claim 16, wherein:
each of the first and second outer gain media has a first length, and
the inner gain medium has a second length shorter than the first length.

18. The laser of claim 16, wherein:
each of the first and second outer gain media comprises a titanium sapphire crystal, and
the inner gain medium comprises a first saturable absorber having a first absorption rate.

19. The laser of claim 18, wherein the mode-locking unit comprises a second saturable absorber having a second absorption rate higher than the first absorption rate.

20. The laser of claim 16, further comprising:
a third beam splitter between the inner gain medium and the fourth curve mirror;
a fourth beam splitter between the inner gain medium and the second curved mirror;
a third gain medium provided on one side of the inner gain medium and configured to reobtain the gain the seed laser light; and
a fifth curved mirror and sixth curved mirror provided on both sides of the third outer gain medium,
wherein the third outer gain medium comprises a nonlinear crystal.
